(19) United States
(12) Patent Application Publication
(10) Pub. No.: US 2002/0192396 A1
(43) Pub. Date: Dec. 19, 2002

(54) Method of titanium/titanium nitride integration

(76) Inventors: Shulin Wang, Campbell, CA (US); Mei Chang, Saratoga, CA (US); Ramanujapuram A. Srinivas, San Jose, CA (US); Avgerinos Gelatos, Redwood City, CA (US)

Correspondence Address: APPLIED MATERIALS, INC., 2881 SCOTT BLVD. M/S 2061, SANTA CLARA, CA, 95050, US

(21) Appl. No.: 09/569,737

(22) Filed: May 11, 2000

(51) Int. Cl. B05D 5/12

(52) U.S. Cl. 427/574; 427/578; 427/579; 427/588

(57) ABSTRACT

A method of forming a film structure (e.g., film stack) comprising titanium (Ti) and titanium nitride (TiN) films is disclosed. In one aspect of the invention, a titanium silicide (TiSiₓ) layer is formed on a Ti film, followed by deposition of a TiN film on the TiSiₓ layer. The TiSiₓ layer protects the underlying Ti film from chemical attack by TiCl₄-based chemistry during subsequent TiN layer deposition. In another aspect of the invention, a cap layer of TiN is deposited between the Ti and TiN layers of a Ti/TiN film structure. The TiN cap layer inhibits chlorine migration from the overlying TiN layer into an underlying contact region, such as, for example, the source or drain of a transistor.

### BACKGROUND OF THE DISCLOSURE

1. Field of the Invention

The invention relates to a method of thin film deposition and, more particularly to a method of forming an integrated titanium/titanium nitride film structure.

2. Description of the Background Art

In the manufacture of integrated circuits, a titanium nitride film is often used as a barrier layer to inhibit the diffusion of metals into regions underlying the barrier layer. These underlying regions include transistor gates, capacitor dielectric, semiconductor substrates, metal lines, and many other structures that appear in integrated circuits.

For example, when a gate electrode of a transistor is fabricated, a barrier layer is often formed between the gate material (e.g., polysilicon) and the metal (e.g., aluminum) of the gate electrode. The barrier layer inhibits the diffusion of the metal into the gate material. Such metal diffusion is undesirable because it potentially changes the characteristics of the transistor, rendering the transistor inoperable. A stack of titanium/titanium nitride (Ti/TiN) films, for example, is often used as a diffusion barrier.

The Ti/TiN stack has also been used to provide contacts to the source and drain of a transistor. For example, in a tungsten (W) plug process, a Ti layer deposited on a silicon (Si) substrate is converted to titanium silicide (TiSiₓ), followed by TiN layer deposition and tungsten (W) plug formation. The conversion of the Ti layer to TiSiₓ is desirable because the TiSiₓ forms a lower resistance contact to the silicon substrate then does the TiN layer. In addition to being a barrier layer, the TiN layer also serves two additional functions: 1) preventing chemical attack of TiSiₓ by tungsten hexafluoride (WF₆) during W plug formation; and 2) acting as a glue layer to promote adhesion of the W plug.

However, as the dimensions of the source and drain contacts are decreased (e.g., source and drain widths less than about 0.2 μm (micrometers)) the aspect ratios of the plug structures may become high (e.g., aspect ratios greater than about 5:1). The aspect ratio is defined as the plug depth divided by its width. For high aspect ratio plug structures, a TiN plug may replace the W plug so as to minimize increases to the contact resistance of the source and drain.

Ti and TiN layers are typically formed using physical and/or chemical vapor deposition techniques. A Ti/TiN combination barrier layer may be formed in a multiple chamber “cluster tool” by depositing a Ti film in one chamber followed by TiN film deposition in another chamber. For example, titanium tetrachloride (TiCl₄) may be reacted with different reactant gases to form both Ti and TiN films using CVD (e.g., under plasma conditions, Ti is formed when TiCl₄ reacts with hydrogen (H₂), and TiN is formed when TiCl₄ reacts with nitrogen (N₂)).

However, when a TiCl₄-based chemistry is used to form a Ti/TiN combination barrier layer, reliability problems can occur. In particular, if the Ti film thickness exceeds about 150 Å, the Ti/TiN stack can peel off an underlying field oxide layer or exhibit a haze, which may result, for example, from TiCl₄ or other species arising from TiCl₄, chemically attacking the Ti film prior to TiN deposition.

Another reliability problem can occur for TiN films. TiN films formed using CVD techniques at process temperatures greater than about 550° C., tend to have intrinsically high tensile stresses (e.g., tensile stress on the order of about 2×10¹⁰ dyne/cm² for a film thickness of about 200 Å). Since tensile forces increase with increasing film thicknesses, cracks can begin to develop in TiN films having thicknesses that exceed about 400 Å. When the process temperatures are reduced below about 500° C., thicker TiN films (e.g., thicknesses above about 1500 Å) having lower tensile stresses (e.g., tensile stress on the order of about 1-2×10⁹ dyne/cm²), without cracks can be produced. However, these low tensile stress TiN films typically have a high Cl content (e.g., chlorine content greater than about 3%). A high chlorine content is undesirable because the chlorine may migrate from the Ti/TiN film stack into the contact region of, for example the source or drain of a transistor, which can increase the contact resistance of such contact region and potentially change the characteristics of the transistor.

Therefore, a need exists in the art for a method of forming a reliable Ti/TiN diffusion barrier for integrated circuit fabrication. Particularly desirable would be a method for forming a reliable Ti/TiN plug.

### SUMMARY OF THE INVENTION

The present invention relates to a method of forming a film structure (e.g., film stack) comprising titanium (Ti) and titanium nitride (TiN) films. In one aspect of the invention, a titanium silicide (TiSiₓ) layer is formed on a Ti film, followed by deposition of a TiN film on the TiSiₓ layer.

The titanium silicide (TiSiₓ) layer is formed, for example, by depositing a silicon film on the Ti layer using plasma-enhanced decomposition of a silicon compound. Reaction between the Si film and a top portion of the Ti layer leads to the formation of a TiSiₓ layer on the Ti layer. A TiN film is subsequently formed on the TiSiₓ using, for example, a reaction between titanium tetrachloride (TiCl₄) and ammonia (NH₃). Alternatively, the TiSiₓ layer is formed using a plasma-enhanced reaction of titanium tetrachloride (TiCl₄) and a silicon compound.

In another aspect of the invention, a cap layer of TiN is formed between the Ti and TiN layers of a Ti/TiN film structure. The TiN cap layer is formed from a thermal reaction of TiCl₄ and NH₃ under a NH₃-rich condition. The TiN cap layer is less than about 100 Å thick.

### BRIEF DESCRIPTION OF THE DRAWINGS

The teachings of the present invention can be readily understood by considering the following detailed description in conjunction with the accompanying drawings, in which:

FIG. 1 depicts a schematic illustration of an apparatus that can be used for the practice of this invention;

FIGS. 2a-2d depict cross-sectional views of a substrate structure at different stages of integrated circuit fabrication in which a titanium silicide (TiSiₓ) layer is formed between titanium (Ti) and titanium nitride (TiN) films of a Ti/TiN film stack; and

FIGS. 3a-3c depict cross-sectional views of a substrate structure at different stages of integrated circuit fabrication in which a TiN cap layer is formed between Ti and TiN films of a Ti/TiN film stack.

### DETAILED DESCRIPTION

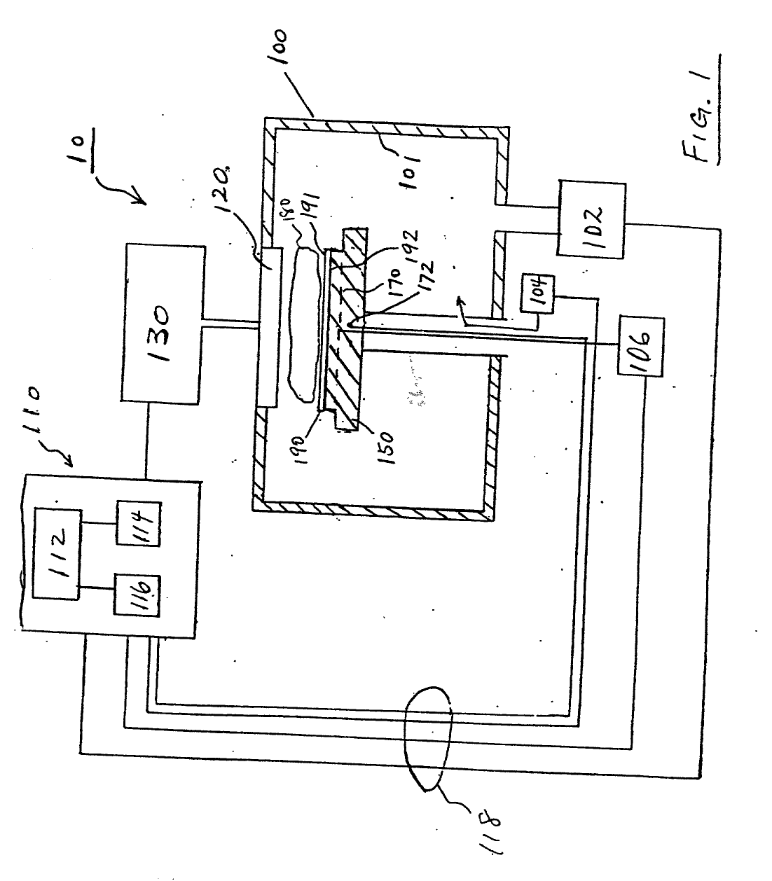

FIG. 1 depicts a schematic illustration of a wafer processing system 10 that can be used to practice embodiments of the present invention. The system 10 comprises a process chamber 100, a gas panel 130, a control unit 110, along with other hardware components such as power supplies 106 and vacuum pumps 102. One example of the process chamber 100 is a TiN chamber which has previously been described in a commonly-assigned U.S. patent application Ser. No. 09/211,998, entitled “High Temperature Chemical Vapor Deposition Chamber”, filed on Dec. 14, 1998, and is herein incorporated by reference. The salient features of process chamber 100 are briefly described below.

Chamber 100

The process chamber 100 generally houses a support pedestal 150, which is used to support a substrate such as a semiconductor wafer 190 within the process chamber 100. The pedestal 150 can typically be moved in a vertical direction inside the chamber 100 using a displacement mechanism (not shown). Depending on the specific process, the semiconductor wafer 190 can be heated to some desired temperature prior to layer deposition.

In chamber 100, the wafer support pedestal 150 is heated by an embedded heater 170. For example, the pedestal 150 may be resistively heated by applying an electric current from an AC power supply 106 to the heater element 170. The wafer 190 is, in turn, heated by the pedestal 150, and can be maintained within a desired process temperature range of, for example, about 450° C. to about 750° C. A temperature sensor 172, such as a thermocouple, is also embedded in the wafer support pedestal 150 to monitor the temperature of the pedestal 150 in a conventional manner. For example, the measured temperature may be used in a feedback loop to control the electric current applied to the heater element 170 by the power supply 106, such that the wafer temperature can be maintained or controlled at a desired temperature which is suitable for the particular process application. The pedestal 150 is optionally heated using radiant heat (not shown).

A vacuum pump 102 is used to evacuate the process chamber 100 and to help maintain the proper gas flows and pressure inside the chamber 100. A showerhead 120, through which process gases are introduced into the chamber 100, is located above the wafer support pedestal 150.

A “dual-gas” showerhead 120 has two separate pathways or gas lines (not shown), which allow two gases to be separately introduced into the chamber 100 without premixing. Details of the showerhead 120 have been disclosed in commonly-assigned U.S. patent application Ser. No. 09/098,969, entitled “Dual Gas Faceplate for a Showerhead in a Semiconductor Wafer Processing System”, filed Jun. 16, 1998, and is herein incorporated by reference.

The showerhead 120 is connected to a gas panel 130, which controls and supplies various gases used in different steps of the process sequence. During wafer processing, a purge gas supply 104 may also provide a purge gas, for example, an inert gas, around the bottom of the pedestal 150, to minimize undesirable deposit formation on the backside of the pedestal 150.

The showerhead 120 and the wafer support pedestal 150 also form a pair of spaced apart electrodes. When an electric field is generated between these electrodes, the process gases introduced into the chamber 100 are ignited into a plasma 180. The electric field can be generated, for example, by connecting the wafer support pedestal 150 to a source of radio frequency (RF) power (not shown) through a matching network (not shown). Alternatively, the RF power source and matching network may be coupled to the showerhead 120, or coupled to both the showerhead 120 and the wafer support pedestal 150.

Plasma enhanced chemical vapor deposition (PECVD) techniques promote excitation and/or disassociation of the reactant gases by the application of the electric field to the reaction zone near the substrate surface, creating a plasma 180 of reactive species. The reactivity of the species in the plasma 180 reduces the energy required for a chemical reaction to take place, in effect lowering the required temperature for such PECVD processes.

Proper control and regulation of the gas flows through the gas panel 130 is performed by mass flow controllers (not shown) and a controller unit 110, such as a computer. The showerhead 120 allows process gases from the gas panel 130 to be uniformly introduced and distributed in the process chamber 100. Illustratively, the control unit 110 comprises a central processing unit (CPU) 112, support circuitry 114, and memories containing associated control software 116. The control unit 110 is responsible for automated control of the numerous steps required for wafer processing—such as wafer transport, gas flow control, temperature control, chamber evacuation, and other steps. The control unit 110 may be one of any form of general purpose computer processor that can be used in an industrial setting for controlling various chambers and sub-processors. The computer processor may use any suitable memory, such as random access memory, read only memory, floppy disk drive, hard disk, or any other form of digital storage, local or remote. Various support circuits may be coupled to the computer processor for supporting the processor in a conventional manner. Software routines as required may be stored in the memory or executed by a second processor that is remotely located. Bi-directional communications between the control unit 110 and the various components of the system 10 are handled through numerous signal cables collectively referred to as signal buses 118, some of which are illustrated in FIG. 1.

Ti/TiN Integration

The following embodiments are methods for titanium/titanium nitride (Ti/TiN) process integration, which advantageously provide a Ti/TiN film stack with improved reliability and good step coverage for the TiN film.

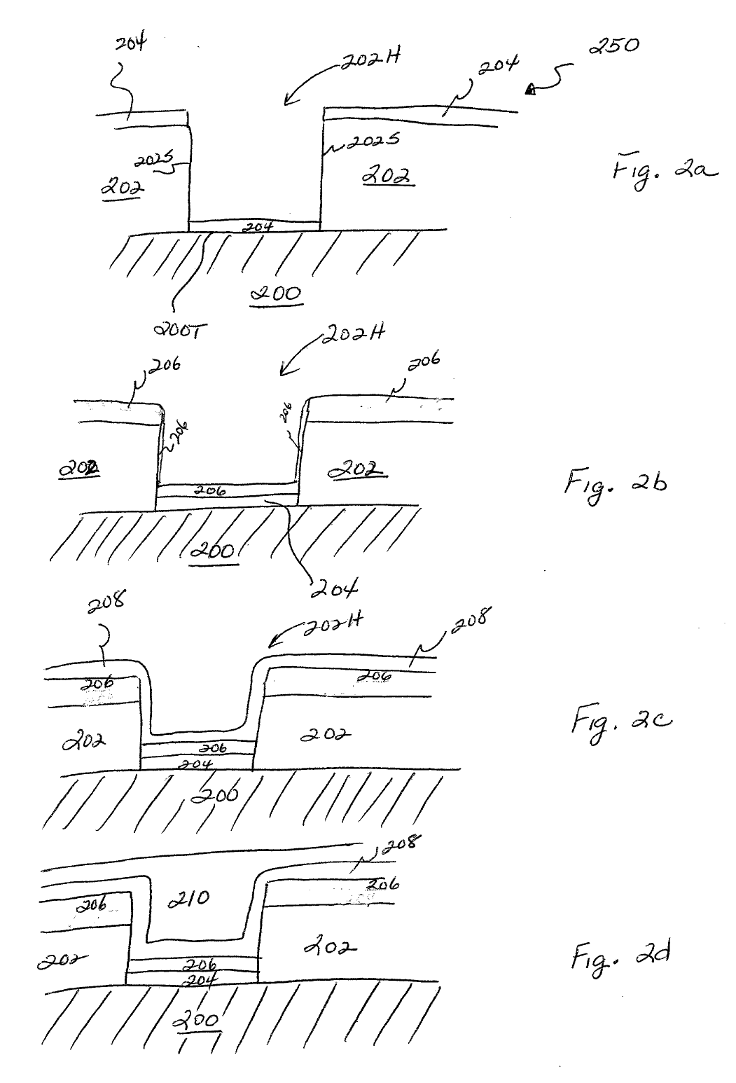

FIGS. 2a-2d illustrate one preferred embodiment of the present invention in which a titanium silicide (TiSiₓ) layer is formed between the Ti and TiN films. In general, the substrate 200 refers to any workpiece upon which film processing is performed, and a substrate structure 250 is used to generally denote the substrate 200 as well as other material layers formed on the substrate 200. Depending on the specific stage of processing, the substrate 200 may be a silicon semiconductor wafer, or other material layer, which has been formed on the wafer. FIG. 2a, for example, shows a cross-sectional view of a substrate structure 250, having a material layer 202 thereon. In this particular illustration, the material layer 202 may be an oxide (e.g., silicon dioxide). The material layer 202 has been conventionally formed and patterned to provide a contact hole 202H extending to the top surface 200T of the substrate 200. A Ti film 204 is formed on the substrate structure 250. The Ti film 204 may be deposited on the substrate structure 250 by a conventional Ti deposition process such as plasma enhanced chemical vapor deposition (PECVD) or physical vapor deposition (PVD).

The deposited Ti film 204 also contacts a portion of the substrate 200 at the bottom 200T of the contact hole 202H. Due to the non-conformal nature of the plasma deposited Ti film 204, the sidewalls 202S of the contact hole 202H are typically not covered by any Ti.

FIG. 2b shows a TiSiₓ layer 206 formed on the Ti film 204. It is believed that the TiSiₓ layer functions to protect the underlying Ti film during TiN film deposition. The TiSiₓ layer also allows the subsequently deposited TiN film to be formed under process conditions optimized for both film characteristics and step coverage.

The TiSiₓ layer 206 is formed by depositing a silicon (Si) containing film on the Ti layer using, for example, plasma-enhanced decomposition of a gas mixture comprising a silicon compound such as silane (SiH₄), disilane (Si₂H₆) or dichlorosilane (SiH₂Cl₂). The Si film can be deposited by chemical vapor deposition (CVD) in a process chamber 100 similar to that shown in FIG. 1. In general, the decomposition of the silicon compound may be performed at a substrate temperature of about 600° C. to about 750° C., a chamber pressure of about 0.5 torr to about 10 torr, a silicon compound flow rate of about 50 sccm to about 500 sccm, a dilutant gas flow rate of about 2 slm to about 5 slm, an RF power of about 100 watts to about 1000 watts, and a plate spacing of about 250 mils to about 900 mils. Dilutant gases such as hydrogen (H₂), argon (Ar), helium (He), or combinations thereof may be added to the gas mixture.

The thickness of the Si film required for forming an effective TiSiₓ layer depends on the thickness of the underlying Ti layer 204. In general, a thicker Ti film 204 requires a thicker Si film. A thickness of about 20 Å is typically sufficient for a 150 Å thick Ti film. Plasma-enhanced Si deposition advantageously provides poor step coverage in the contact hole 202H, resulting in the deposition of a thin Si layer (e.g., thickness less than about 50 Å) on the contact and side walls and a thicker Si deposition on the surrounding oxide layer 202. Plasma-enhanced deposition of the thin Si layer on the contacts is desirable because the resistance of the contacts is not increased when such a thin Si layer is converted to TiSiₓ.

The Si film 206 is subsequently allowed to react with the Ti layer 204, by annealing it at a high temperature (e.g., a temperature over 600° C.). Alternatively, the Si film 206 may react with the Ti layer 204 during Si film deposition. The reaction results in the formation of a layer which may comprise TiSiₓ, TiSiₓO_{y}, or other “alloyed” species containing Ti and Si (where x and y denote amounts of Si and O relative to Ti). In this illustration the layer may also comprise TiSiO because the oxide layer 202 provides a source of oxygen. In other embodiments without an oxygen source, the TiSiO will not be formed. Instead, other “Ti—Si alloyed” species may be present, depending on the specific substrate structure 250.

Alternatively, the TiSiₓ layer 206 may be directly formed on the substrate structure 250 of FIG. 2a using a plasma-enhanced reaction of titanium tetrachloride (TiCl₄) and a silicon compound such as silane (SiH₄), disilane (Si₂H₆) or dichlorosilane (SiH₂Cl₂). The reaction can be performed in a process chamber 100 similar to that shown in FIG. 1, in which TiCl₄ and SiH₄, for example, are separately introduced into the chamber 100 via the dual-gas showerhead 120. In general, the reaction may be performed at a substrate temperature of about 600° C. to about 750° C., a chamber pressure of about 0.5 torr to about 10 torr, a TiCl₄ flow rate of about 1 sccm to about 10 sccm, a SiH₄ flow rate of about 10 sccm to about 100 sccm, an RF power of about 100 watts to about 1000 watts and a plate spacing of about 250 mils to about 900 mils.

To increase the deposition rate and to reduce the chlorine content of the deposited film, a dilutant gas such as hydrogen (H₂), argon (Ar), helium (He), or combinations thereof may be added to the reaction mixture. The dilutant gas preferably has a flow rate of about 2 slm to about 5 slm. Alternatively, other gases comprising a silicon element, such as, for example, disilane (Si₂H₈) and dichlorosilane (SiH₂Cl₂), may also be used in place of SiH₄ to react with TiCl₄, and the processing conditions can be adjusted to suit specific needs. The plasma deposited TiSiₓ layer 206 may, for example, have a thickness in a range of about 20 Å to about 100 Å, and more preferably, about 50 Å.

After the formation of the TiSiₓ layer 206, a TiN layer 208 is deposited in the contact hole 202H, as illustrated in FIG. 2c. The TiN film 208 can be formed, for example, by CVD using a reaction of TiCl₄ and NH₃ in the chamber 100 of FIG. 1. In one embodiment, helium (He) and nitrogen (N₂) are introduced into the chamber 100, along with TiCl₄, via one pathway (gas line) of the showerhead 120. NH₃, along with N₂, is introduced into the chamber 100 via the second pathway of the showerhead 120. He and argon (Ar), or other inert gases, may also be used, either singly or in combination (i.e., as a gas mixture) within either gas line of the showerhead 120. A bottom inert gas purge flow (e.g., Ar) of about 2000 sccm is also established through a separate gas line and gas supply 104 provided at the bottom of the chamber 100. Typically, the reaction can be performed at a TiCl₄ flow rate of about 3 sccm to about 25 sccm, with a He gas flow of about 500 sccm to about 2000 sccm, and N₂ flow of about 500 sccm to about 2000 sccm, introduced into the chamber 100 though the first pathway of the showerhead 120. The NH₃ with a flow rate of about 30 sccm to about 200 sccm along with N₂ at a flow rate of about 500 sccm to about 5000 scam may be introduced in the chamber 100 through the second pathway of the showerhead 120. A total pressure range of about 3 torr to about 30 torr and a pedestal temperature between about 400° C. to about 700° C. may be used.

One of the advantages of incorporating a layer containing TiSiₓ in this integration technique is the process and chemical compatibility with both Ti and TiN deposition. It is believed that the presence of the TiSiₓ layer protects the underlying Ti layer 204 against chemical attack during the subsequent TiCl₄-based TiN deposition step. Since the TiSiₓ is chemically compatible with both Ti and TiN, the incorporation of the TiSiₓ layer 206 in the Ti/TiN integration process provides a film structure with high reliability, good barrier layer properties and excellent TiN step coverage. In general, the TiSiₓ layer of the present invention can be used in conjunction with other TiCl₄-based processes for TiN deposition, including plasma enhanced CVD using TiCl₄/N₂, among others.

Thereafter, as illustrated in FIG. 2d, a tungsten (W) plug 210 is formed on the TiN layer 208 of FIG. 2c. The W plug 210 may be formed from, for example, a reaction between WF₆ and H₂. Adhesion of the W-plug layer is improved by the presence of the TiN layer 208.

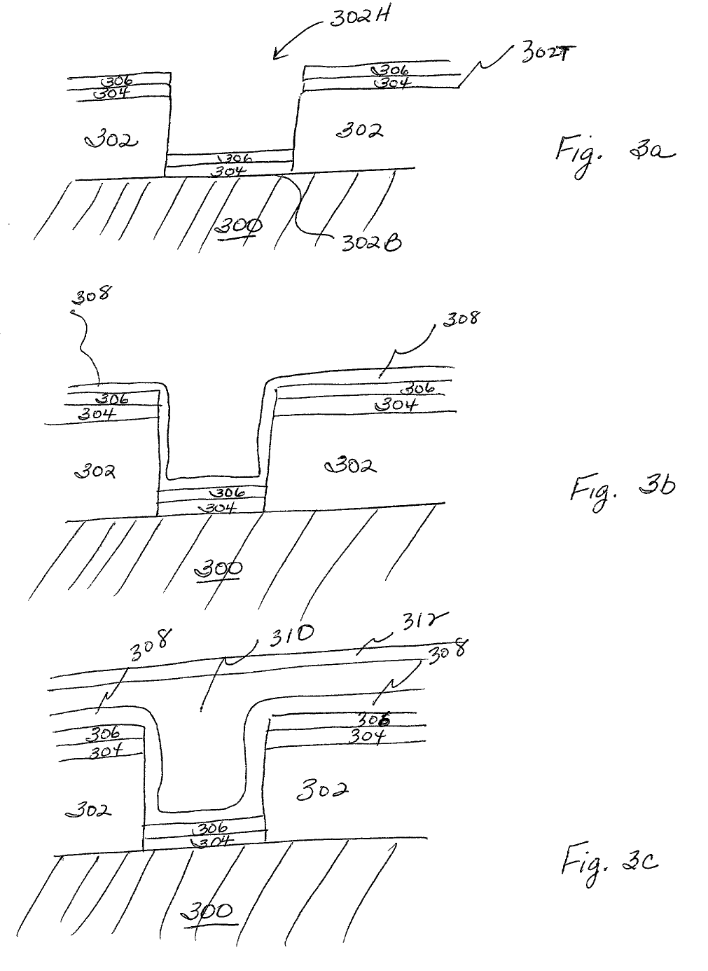

FIGS. 3a-3c illustrate another embodiment of the present invention in which a TiN cap layer is formed between a Ti layer and a TiN layer of a Ti/TiN film stack. FIG. 3a shows a Ti film 304 deposited on an underlying patterned material layer 302 and contacting a substrate 300 at the bottom 302B of a contact hole 302H. As previously described in connection with FIG. 2a, the Ti film 304 covers primarily the top 302T of the patterned layer 302 and the bottom 302B of the contact hole 302H. A TiSiₓ layer 306 is formed on the Ti film 304. The formation of the Ti layer 304 along with the TiSiₓ layer 306 have previously been described in connection with FIGS. 2a-2b.

FIG. 3b shows a TiN cap layer 308 formed on the TiSiₓ layer 306. It is believed that the TiN cap layer 308 functions to inhibit the migration of chlorine from an overlying TiN film, formed in a subsequent fabrication step, into the underlying contact region, such as, for example, the source or drain of a transistor. Since the TiN cap layer 308 inhibits the migration of chlorine from the overlying TiN film into the underlying contact region, thicker overlying TiN films (e.g., TiN film thickness greater than about 1500 Å) with lower tensile stresses and without cracks may comprise the Ti/TiN film stack. The TiN cap layer 308 is preferably less than about 100 Å thick.

The TiN cap layer 308 is formed from a thermal reaction of TiCl₄ and NH₃ under a NH₃-rich condition. The reaction may be performed in a process chamber 100 similar to that shown in FIG. 1, in which TiCl₄ and NH₃ are introduced into the chamber 100 via the showerhead 120. In general, the NH₃-rich condition may refer to a TiCl₄/NH₃ ratio that is greater than, for example, about 1:8.5. The thermal reaction may be performed at a substrate temperature that is less than about 550° C., a chamber pressure of about 5 torr to about 30 torr, a TiCl₄ flow rate in a range of about 5 sccm to about 20 sccm, and a NH₃ flow of about 50 sccm to about 300 sccm. The TiCl₄/NH₃ ratio is preferably maintained at about 1:15, with the TiCl₄ flow rate at about 7 scam to about 8 scam, the NH₃ flow rate at about 120 scam, and a total pressure of about 10 torr.

A dilutant gas such as He, N₂, Ar, or combinations thereof, may be added to the gas mixture. The dilutant gas preferably has a flow rate in a range of about 500 sccm to about 3000 sccm.

After the TiN cap layer 308 is deposited on the TiSiₓ layer 306, it is subjected to either a NH₃ treatment or hydrogen plasma treatment. The NH₃ treatment or hydrogen plasma treatment is used to eliminate chlorine from the TiN cap layer 308. The NH₃ treatment or the hydrogen plasma treatment may be performed in a process chamber similar to that shown in FIG. 1.

In general, the NH₃ treatment may be performed at a substrate temperature of about 500° C., a chamber pressure of about 3 torr to about 30 torr, and a NH₃ flow rate of about 50 scam to about 500 sccm. A dilutant gas such as He, N₂, Ar, or combinations thereof, may be added to the NH₃ flow. The dilutant gas preferably has a flow rate in a range of about 500 scam to about 3000 scam. Typically, a NH₃ treatment of less than about 1 minute is sufficient for a TiN cap layer having a thickness of about 50 Å to about 100 Å.

Alternatively, the hydrogen plasma treatment may be performed at a substrate temperature of about 500° C., a chamber pressure of about 0.5 torr to about 10 torr, an RF power of about 600 watts to about 900 watts, a plate spacing of about 250 mils to about 900 mils, and a H₂ flow rate of about 500 scam to about 5000 sccm. A dilutant gas such as He, N₂, Ar, or combinations thereof, may be added to the H₂ flow. The dilutant gas preferably has a flow rate in a range of about 500 scam to about 3000 scam. Typically, a hydrogen plasma treatment of less than about 1 minute is sufficient for a TiN cap layer having a thickness of about 200 Å to about 250 Å.

The relative ratio of TiCl₄ and NH₃ has a direct bearing on the Cl content and step coverage of the TiN cap layer 208. Typically, reaction mixtures with higher TiCl₄:NH₃ ratios tend to form TiN films with high Cl concentrations and good step coverage. In contrast, reaction mixtures with lower TiCl₄:NH₃ ratios tend to form TiN films with poor step coverage and low Cl concentrations. The present invention strikes a compromise by depositing a TiN cap layer 308 under a NH₃-rich condition followed by a NH₃ or H plasma treatment, which provides a TiN cap layer with a chlorine content that is less than about 1%.

Thereafter, as illustrated in FIG. 3c, a thick TiN layer 310 (e.g., thickness greater than about 1000 Å) may be formed on the TiN cap layer 308 of FIG. 3b at reduced a temperatures (e.g., temperatures less than 550° C.). The deposition of the thick TiN layer 310 has previously been described in connection with FIG. 2c.

Alternatively, a second cap layer 312 may be formed on the TiN layer 310 to prevent Cl migration into an overlying material layer (not shown).

The specific process conditions disclosed in the above discussion are meant for illustrative purposes only. Other combinations of process parameters such as precursor and inert gases, flow ranges, pressure and temperature may also be used in forming the integrated Ti/TiN film stack of the present invention, which incorporate a TiSiₓ layer and/or a TiN cap layer.

Although several preferred embodiments, which incorporate the teachings of the present invention, have been shown and described in detail, those skilled in the art can readily devise many other varied embodiments that still incorporate these teachings.

What is claimed is:

1. A method of thin film deposition for integrated circuit fabrication, comprising the steps of:
(a) forming a titanium film on a substrate;
(b) forming a titanium silicide layer on the titanium film, wherein the titanium silicide layer is formed from a plasma reaction of a gas mixture comprising a silicon compound; and
(c) forming a titanium nitride layer on the titanium silicide layer.

2. The method of claim 1 wherein the titanium silicide layer of step (b) further comprises oxygen.

3. The method of claim 1 wherein the silicon compound of step (b) is selected from the group of silane (SiH₄), disilane (Si₂H₆), or dichlorosilane (SiH₂Cl₂).

4. The method of claim 1 wherein the plasma reaction of step (b) comprises the steps of:
(d) decomposing said gas mixture comprising the silicon compound in the presence of an electric field to form a silicon film on the titanium film; and
(e) exposing the silicon film formed in step (d) and the titanium film to an elevated temperature to cause a reaction between the silicon film and the titanium film to form the titanium silicate layer.

5. The method of claim 4 wherein step (d) is performed at a temperature in a range of about 600° C. to about 750° C.

6. The method of claim 4 wherein step (d) is performed at a pressure in a range of about 0.5 torr to about 10 torr.

7. The method of claim 4 wherein the silicon compound of step (d) has a flow rate in a range of about 50 sccm to about 500 sccm.

8. The method of claim 4 wherein the gas mixture of step (d) further comprises a dilutant gas.

9. The method of claim 8 wherein the dilutant gas is selected from the group of hydrogen (H₂), argon (Ar), helium (He) and combinations thereof.

10. The method of claim 8 wherein the dilutant gas has a flow rate in a range of about 2 slm to about 5 slm.

11. The method of claim 4 wherein the electric field of step (d) is a radio frequency (RF) power.

12. The method of claim 11 wherein the RF power is in a range of about 100 watts to about 1000 watts.

13. The method of claim 4 wherein step (e) is performed at a temperature greater than 600° C.

14. The method of claim 1 wherein the plasma reaction of step (b) comprises the step of:
(f) reacting said gas mixture comprising the silicon compound with titanium tetrachloride (TiCl₄) in the presence of an electric field.

15. The method of claim 14 wherein step (f) is performed at a TiCl₄ flow rate in a range of about 1 sccm to about 10 sccm.

16. The method of claim 14 wherein step (f) is performed at a silicon compound flow rate in a range of about 10 sccm to about 100 sccm.

17. The method of claim 14 wherein step (f) is performed at a pressure in a range of about 0.5 torr to about 10 torr.

18. The method of claim 14 wherein step (f) is performed at a temperature in a range of about 600° C. to about 750° C.

19. The method of claim 14 wherein the electric field is a radio frequency (RF) power.

20. The method of claim 19 wherein the RF power is in a range of about 100 watts to about 1000 watts.

21. The method of claim 14 wherein the gas mixture further comprises a dilutant gas.

22. The method of claim 21 wherein the dilutant gas is selected from the group of hydrogen (H₂), argon (Ar), helium (He), nitrogen (N₂), and combinations thereof.

23. The method of claim 21 wherein step (f) is performed at a dilutant gas flow rate in a range of about 2 slm to about 5 slm.

24. The method of claim 1 wherein step (c) is performed by reacting titanium tetrachloride (TiCl₄) with a gas comprising nitrogen (N).

25. The method of claim 24 wherein the gas comprising nitrogen (N) is ammonia (NH₃).

26. The method of claim 24 wherein step (c) is performed at a TiCl₄ flow rate in a range of about 3 sccm to about 25 sccm.

27. The method of claim 24 wherein the gas comprising nitrogen has a flow rate in a range of about 30 sccm to about 200 sccm.

28. The method of claim 24 wherein the gas mixture further comprises a dilutant gas.

29. The method of claim 28 wherein the dilutant gas is selected from the group of hydrogen (H₂), argon (Ar), helium (He), nitrogen (N₂), or combinations thereof.

30. The method of claim 28 wherein step (c) is performed at a dilutant gas flow rate in a range of about 500 sccm to about 2000 sccm.

31. The method of claim 24 wherein step (c) is performed at a pressure in a range of about 3 torr to about 30 torr.

32. The method of claim 24 wherein step (c) is performed at a temperature in a range of about 400° C. to about 700° C.

33. The method of claim 1 further comprising the step of:
(g) forming a titanium nitride (TiN) cap layer on the titanium silicide layer prior to forming the TiN layer of step (c), wherein the TiN cap layer is formed by reacting titanium tetrachloride (TiCl₄) and ammonia (NH₃) under a NH₃rich condition.

34. The method of claim 33 further comprising the step of:
(h) treating the TiN cap layer formed in step (g) to remove chlorine therefrom.

35. The method of claim 33 wherein the NH₃-rich condition has NH₃ present in an amount greater than 8.5 times that of TiCl₄.

36. The method of claim 33 wherein step (g) is performed at a TiCl₄ flow rate in a range of about 5 sccm to about 20 sccm.

37. The method of claim 33 wherein step (g) is performed at a pressure in a range of about 5 torr to about 30 torr.

38. The method of claim 33 wherein step (g) is performed at a temperature less than about 550° C.

39. The method of claim 33 wherein the titanium nitride cap layer is not more than about 100 Å thick.

40. The method of claim 34 wherein step (h) comprises a NH₃ treatment performed at a temperature of about 500° C. and a NH₃ flow rate of about 50 sccm to about 500 sccm.

41. The method of claim 34 wherein step (h) comprises a hydrogen plasma treatment performed at a temperature of about 500° C., a H₂ flow rate of about 500 sccm to about 5000 sccm and an RF power of about 600 watts to about 900 watts.

42. A method of forming a barrier layer for use in integrated circuit fabrication, comprising the steps of:
(a) providing a substrate structure having an oxide layer on a silicon substrate;
(b) forming an aperture through the oxide layer to a top surface of the silicon substrate;
(c) forming a titanium film on at least portions of the oxide layer and the silicon substrate;
(d) forming a titanium silicide layer on the titanium film;
(e) forming a cap layer of titanium nitride on the titanium silicide layer; and
(f) forming a titanium nitride film on the titanium nitride cap layer.

43. The method of claim 42 further comprising the step of:
(g) forming a second cap layer on the titanium nitride film of step (f).

44. The method of claim 42 wherein the titanium silicide layer of step (d) is formed from a plasma reaction of a gas mixture comprising a silicon compound.

45. The method of claim 44 wherein the plasma reaction of step (d) comprises the steps of:
(h) decomposing said gas mixture comprising the silicon compound in the presence of an electric field to form a silicon film on the titanium film; and
(i) exposing the silicon film formed in step (h) and the titanium film to an elevated temperature to cause a reaction between the silicon film and the titanium film to form the titanium silicate layer.

46. The method of claim 44 wherein the plasma reaction of step (d) comprises the step of:
(j) reacting said gas mixture comprising the silicon compound with titanium tetrachloride (TiCl₄) in the presence of an electric field.

47. The method of claim 44 wherein the silicon compound is selected from the group of silane (SiH₄), disilane (Si₂H₆), or dichlorosilane (SiH₂Cl₂).

48. The method of claim 42 wherein step (e) comprises the steps of:
(k) reacting titanium tetrachloride (TiCl₄) and ammonia (NH₃) under a NH₃-rich condition; and
(l) treating the TiN cap layer formed in step (k) to remove chlorine therefrom.

49. The method of claim 48 wherein the NH₃-rich condition has NH₃ present in an amount greater than 8.5 times that of TiCl₄.

50. A computer storage medium containing a software routine that, when executed, causes a general purpose computer to control a deposition chamber using a method of thin film deposition comprising the steps of:
(a) forming a titanium film on a substrate;
(b) forming a titanium silicide layer on the titanium film, wherein the titanium silicide layer is formed from a plasma reaction of a gas mixture comprising a silicon compound; and
(c) forming a titanium nitride layer on the titanium silicide layer.

51. The computer storage medium of claim 50 wherein the plasma reaction of step (b) comprises the steps of:
(d) decomposing said gas mixture comprising the silicon compound in the presence of an electric field to form a silicon film on the titanium film; and
(e) exposing the silicon film formed in step (d) and the titanium film to an elevated temperature to cause a reaction between the silicon film and the titanium film to form the titanium silicate layer.

52. The computer storage medium of claim 50 wherein the plasma reaction of step (b) comprises the step of:
(f) reacting said gas mixture comprising the silicon compound with titanium tetrachloride (TiCl₄) in the presence of an electric field.

53. The computer storage medium of claim 50 wherein the silicon compound is selected from the group of silane (SiH₄), disilane (Si₂H₆), or dichlorosilane (SiH₂Cl₂).

54. The computer storage medium of claim 50 further comprising the steps of:
(g) forming a titanium nitride (TiN) cap layer on the titanium silicide layer prior to forming the TiN layer of step (c), wherein the TiN cap layer is formed by reacting titanium tetrachloride (TiCl₄) and ammonia (NH₃) under a NH₃rich condition; and
(h) treating the TiN cap layer formed in step (g) to remove chlorine therefrom.

55. The computer storage medium of claim 54 wherein the NH₃rich condition of step (g) has NH₃ present in an amount greater than 8.5 times that of TiCl₄.
